(19) United States
(12) Patent Application Publication
(10) Pub. No.: US 2006/0026543 A1
(43) Pub. Date: Feb. 2, 2006

(54) ACCURATE TIMING ANALYSIS OF INTEGRATED CIRCUITS WHEN COMBINATORIAL LOGIC OFFERS A LOAD

(75) Inventors: Somasekar JAYARAMAN, Bangalore (IN); Venkateswaran GOVINDARAJAN, Bangalore (IN); Sanjib BASU, Bangalore (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 10/710,699

(22) Filed: Jul. 29, 2004

(51) Int. Cl. G06F 17/50; G06F 9/45

(52) U.S. Cl. 716/6; 703/19

(57) ABSTRACT

The accuracy of timing analysis of an integrated circuit is enhanced based on an observation that the capacitive load offered by a combinatorial element (e.g., logic gate) is more when the value on the output path switches, compared to in a scenario when the output path does not switch. In an embodiment, the capacitance value corresponding to the case of switching is associated with cells if setup time violations are of concern, and the capacitance value corresponding to the non-switching case is associated with cells (libraries) if hold time violations are of concern.

### BACKGROUND OF INVENTION

1. Field of the Invention

The present invention relates to computer-aided design (CAD) of integrated circuits, and more specifically to a method and apparatus to perform accurate timing analysis of integrated circuits when combinatorial logic offers a load to other components of an IC

2. Related Art

Integrated circuits (ICs) generally contain various components (flip-flops, pins, logic gates, multiplexers, etc) connected in a desired topology. Components such as logic gates and multiplexers, which do not store bit values or state information in general, are generally referred to as combinatorial logic. On the other hand, components such as flip-flops, which store state information, are referred to as sequential elements.

Timing analysis is often performed during the design phase of an IC. Typically, digital data representing the IC design is analyzed using various design tools. Timing analysis is generally performed to ensure that the signals are propagated by combinatorial logic and captured by sequential elements in a time duration permitted by the period of a clock signal used to drive the IC. In general, it is desirable to use a clock signal of short period to the extent timing violations are not experienced in the operation of an IC, and timing analysis is performed to detect any potential timing violations.

One factor considered in timing analysis is the load offered at the output of each component (“present component”) by a subsequent component (connected to the output). A higher load (offered by the subsequent component(s)) generally requires greater propagation time for a signal generated (as an output) by the present component. In general, the propagation times need to be considered in timing analysis since the clock frequency/period driving an IC is determined by the propagation times.

At least for such a reason it is desirable to perform timing analysis, which takes into consideration accurate load offered by combinatorial logic.

### BRIEF DESCRIPTION OF DRAWINGS

The present invention will be described with reference to the following accompanying drawings.

FIG. 1 is a diagram illustrating the details of an example circuit in which various aspects of the present invention may be implemented.

FIG. 2 is a timing diagram illustrating the manner in which setup and hold violations may be encountered if the capacitive load of a combinatorial element is not accurately computed.

FIG. 3A is a flowchart illustrating the manner in which accuracy of timing analysis may be improved according to an aspect of the present invention.

FIG. 3B is a circuit diagram depicting the details of a cell containing multiple logic gates.

FIGS. 4A-4D illustrate the manner in which the capacitance may be computed and the approximate capacitance value when the output of a NAND gate switches.

FIGS. 5A-5D illustrate the manner in which the capacitance may be computed and the approximate capacitance value when the output of a NAND gate does not switch.

FIG. 6 is a block diagram illustrating the details of a system operable by software instructions to provide several features of the present invention.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

An aspect of the present invention improves the accuracy of timing analysis of an integrated circuit based on a recognition that the capacitance (and thus the load) offered at an input pin of a combinatorial element is higher when the output of the combinatorial element switches state compared to a scenario in which the output does not change. A combinatorial element generally refers to components such as logic gates.

In an embodiment described below, a first capacitance value offered at an input pin of a combinatorial element is determined when the output path (of the combinatorial element) is switching. Similarly, a second capacitance value at the input pin is determined when the output path is not switching. The first capacitance value is associated to the input pin of the combinatorial element while performing timing analysis of the integrated circuit for setup time errors. Similarly, the second capacitance value is associated to the input pin of the combinatorial element while performing timing analysis of the integrated circuit for hold time errors.

Such a determination and association of different value of capacitance to the input pin of the combinatorial element for different analysis conditions generally results in accurate representation of propagation delays in the operation of the combinatorial logic and hence may result in accurate timing analysis.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well structures or operations are not shown in detail to avoid obscuring the invention.

2. Example Circuit

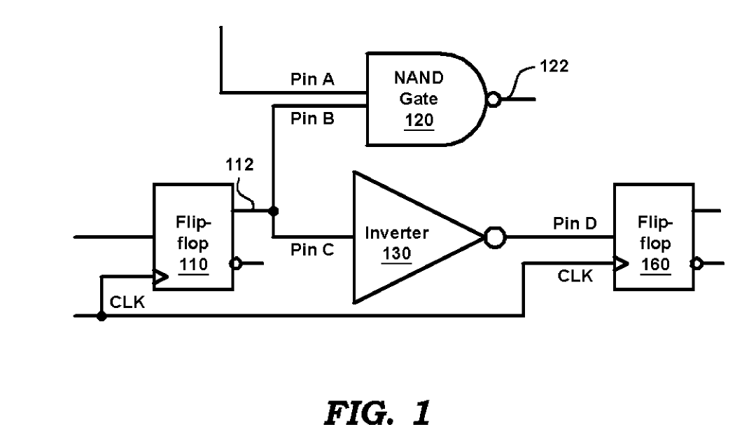

FIG. 1 is a circuit diagram of an example circuit, which is used to illustrate the manner in which timing analysis of ICs can be performed accurately according to several aspects of the present invention. The example circuit of FIG. 1 is shown containing flip-flops 110 and 160, NAND gate 120 and inverter 130. Each element is described below in further detail.

The output (path 112) of flip-flop 110 is shown connected to pin B of NAND gate 120 and pin C of inverter 130 and hence the load on output path 112 is affected by capacitance at pin B of NAND gate and capacitance at pin C of inverter 130. When a higher load is offered on path 112, flip-flop 110 may generate output signals with a corresponding delay.

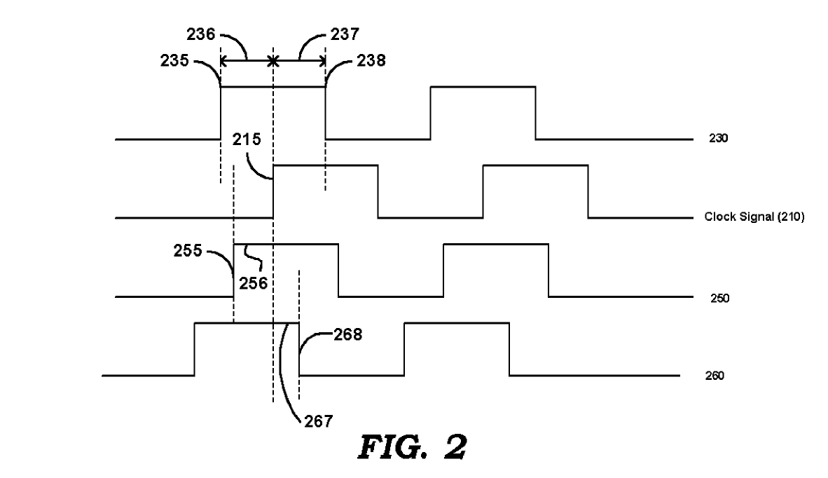

Flip-flop 160 is shown clocked by CLK signal and receiving the output of inverter 130 on D-input. As may be appreciated, for accurate latching of data received on D-input, the D-input and CLK input need to be received with appropriate timing relationship (as described in further detail below with reference to FIG. 2). Over-estimation or under-estimation of delays in the generation of output signals of flip-flop 110 (and inverter 130) may lead to inaccurate operation of flip-flop 160.

NAND gate 120 represents an example combinatorial element, which offers a higher load at pin B (path 112) when the output at path 122 switches, in comparison to a situation in which path 122 does not switch. As may be appreciated, the output of a 2-input NAND gate switches in response to a bit change on one pin, when the other pin is at logic high (1). As may be readily observed, NAND gate 120 is driven by flip-flop 160.

An aspect of the present invention takes advantage of the observation that the offered load is different depending on whether the output of a combinatorial element switches or not, and enables accurate timing analysis of integrated circuits, as described below with examples. Example problems that would be presented if difference of load is not taken into account, is first described below.

3. Example Problems

FIG. 2 is a timing diagram illustrating the example problems caused if the load offered on an output path is underestimated or overestimated. Waveforms 210 and 230 illustrate the desired timing relationship for proper operation of flip-flop 160. In particular, waveforms 210 and 230 respectively represent the CLK and D-inputs of D-flip flop 160.

The timing of waveforms 210 and 230 needs to be such that duration (236) between rising edge 235 of D input and clock edge 215 needs to be greater than or equal to a setup time required by the implementation of D-flip flop. Similarly, the duration (237) between clock edge 215 and falling edge 238 of D input also needs to be greater than or equal to a hold time specification.

Waveform 250 illustrates the failure of setup time requirement if the load offered by NAND gate 120 on path 112 is substantially more than an expected value. As may be appreciated, in case of such underestimation, D-input would be received later than expected. Thus, the D-input of flip-flop 160 would be received later than waveform 230, as depicted by waveform 250. Assuming that time duration 256 between clock edge 215 and rising edge 255 (of waveform 250) is less than the corresponding setup time,OLE_LINK1 flip-flop 160 may not latch the data value on D-input accurately (which is undesirable).

OLE_LINK1Waveform 260 represents the D-input if the load offered by NAND gate 120 on path 112 is substantially overestimated. In comparison to waveform 250, waveform 260 occurs sooner in time. Assuming that time duration 267 between clock edge 215 and falling edge 268 (of waveform 260) is less than the corresponding hold time, flip-flop 160 may not latch the data value on D-input accurately (which is undesirable).

While the circuit of FIG. 1 merely contains a few representative elements for conciseness, it should be understood that the errors in timing analysis may be compounded with many more elements being connected in series, and thereby eventually leading to the setup time and hold time violations somewhere in the integrated circuits during operation (production/application deployment).

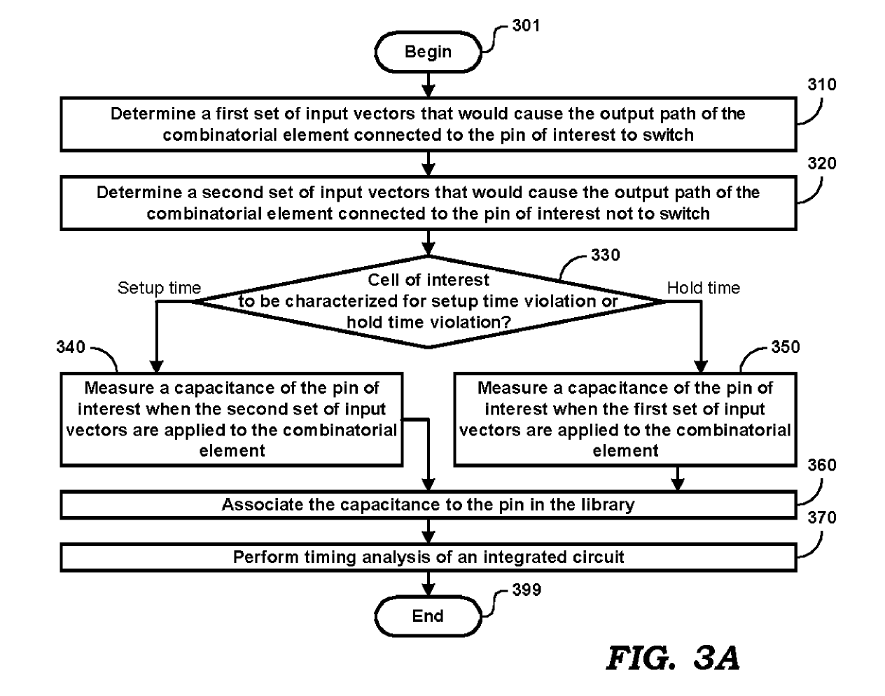

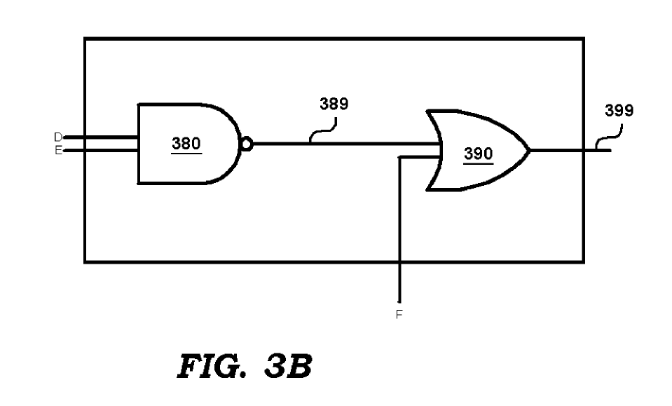

It is therefore desirable that the timing analysis takes into account the difference of offered loads (by combinatorial elements). A cell library may be accurately characterized using various aspects of the present invention, as described below in further detail with reference to FIG. 3A.

4. Characterizing Cell Libraries for Accurate Timing Analysis

FIG. 3A is a flow chart illustrating the manner in which cells (formed of combinatorial logic) contained in each cell library can be characterized for accurate timing analysis according to various aspects of the present invention. As is well known, multiple libraries are provided for the same functional blocks, with each library generally being designed for a specific combination of PVT (process, voltage, temperature) conditions.

In addition, each cell may be designed using one or more logic gates or custom designed. A combinatorial element refers to each of such logic gates or a portion of the custom circuit which behaves as a logic gate in terms of switching the value on a path (either internal to the cell or providing as an external output) when appropriate input vectors are applied.

Continuing with reference to FIG. 3A, the method of FIG. 3 is described with reference to example circuit of FIG. 1 for illustration. The flow chart begins at step 301 and control is immediately passed to step 310.

In step 310, a first set of input vectors that would cause the combinatorial element connected to the pin of interest to switch. In the example circuit of NAND gate 120 of FIG. 1, the input vectors may equal 10 (1 on pin A and 0 on pin B) and 11 assuming pin B is sought to be characterized.

In step 320, a second set of input vectors that would not cause the stage connected to the pin of interest may be determined. With respect to NAND gate 120, the input vectors may equal 00 and 01.

In step 330, a determination is made as to whether a cell of interest needs to be characterized to check setup time or hold time violations. In an embodiment, if the cell is from a library designed for a strong process corner (and/or high temperatures), the signals in the data path are assumed to be propagating faster, and thus hold time violation is of particular concern. On the other hand, if the cell is from a library intended for a weak process corner, setup time violation is of particular concern. Using such considerations, a determination may be made as to whether the cell needs to be characterized for setup time or hold time violation. The data in a library may provide the corresponding information (as to whether the library is designed for strong or weak processor corner, etc.).

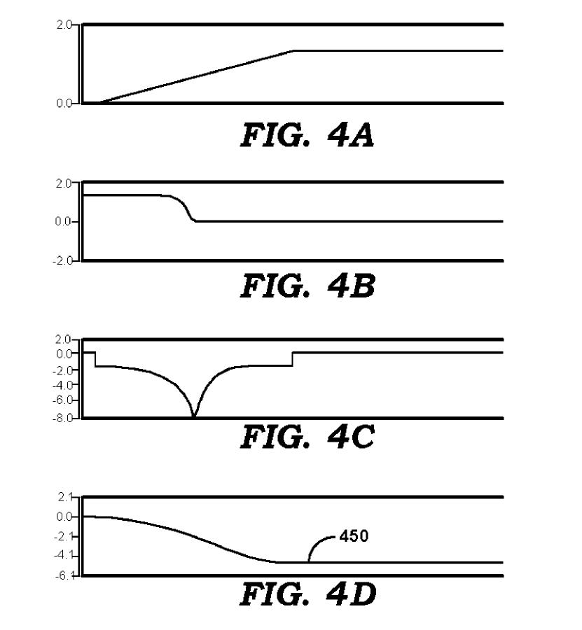

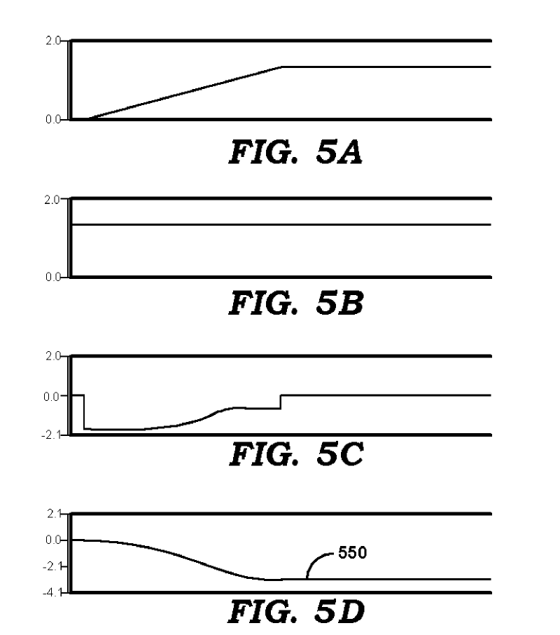

In step 340, the capacitance of the pin(s) of interest is measured when the second set of input vectors are applied to the combinatorial element. With reference to the example circuit of FIG. 1, system may determine a capacitance value at pin B when the second set of input vectors noted above are applied to the NAND Gate 120. In general, design tools (such as SPICE simulator or related utilities) provide the ability to measure the capacitance, and any of such tools may be used to measure the capacitance. The principle underlying an example approach is described below with reference to FIGS. 4A-4D and 5A-5D. Control then passes to step 360.

In step 350, the capacitance of the pin of interest is measured when the first set of input vectors are applied to the stage. The capacitance may be measured similar to as in step 340. The capacitance thus measured may represent a maximum capacitance (Cmax), and thus maximum load offered by NAND gate 120. Control then passes to step 360.

In step 360, the capacitance thus measured may be associated to the pin in the library. In general, such association is performed by storing the corresponding value in a pre-determined location/data structure, depending on the implementation of the design tools. In step 370, timing analysis of the integrated circuit is performed taking into consideration the capacitance values thus stored in step 360.

Due to the use of one of the two capacitance values as described above, the actual capacitance offered at each pin during production/application use may equal the values associates in step 360. Accordingly, the timing analysis may be accurate. The flow chart ends at step 399.

Even though the description above is provided with reference to a cell containing a single logic gate, it should be appreciated that the technique can be applied to cells containing multiple logic gates as well. In such a scenario, the behavior/operation of the combinatorial element directly connected to the input pin sought to be characterized is of particular interest. For example, with reference to the cell of FIG. 3B containing NAND gate 380 and OR gate 390, to characterize pin D, input vectors are determined with reference to pins D and E such that the value on path 389 switches (step 310). The description is continued with an illustration of determination of capacitance values at pin B can be determined.

5. Determining Capacitance Values

FIGS. 4A-4D and 5A-5D contain waveforms illustrating the manner in which the capacitance at an input pin can be determined and also that the capacitance in case an output path switches is greater than in the case when the output path does not switch. In particular, FIGS. 4A through 4D are related to the case in which output path is switching, and FIGS. 5A through 5D are related to the case in which output path is not switching. In all the 8 timing diagrams, the X-axis represents time scale and Y-axis will be clear from the context.

With reference to FIGS. 4A-4D, assuming pin B of FIG. 1 is sought to be characterized, pin A is maintained at 1, and an input transition (e.g., 0 to 1) is applied at pin B. FIG. 4A depicts the voltage level of pin B rising from logic 0 (0 volts) to logic 1 (1.5 Volts). FIG. 4B depicts the output value on path 122 switching from logic high to logic low. FIG. 4C depicts the current on input path corresponding to pin B. As may be easily observed, there is a high current (of the order of −8 micro ampere maximum). The charge at pin B may be computed by integrating the curve of FIG. 4C, and the resulting values are represented by the curve of FIG. 4D.

With reference to FIGS. 5A-5D, pin A is maintained at 0, and an input transition (e.g., 0 to 1) is applied at pin B. FIG. 5A depicts the voltage level of pin B rising from logic 0 (0 volts) to logic 1 (1.5 Volts). FIG. 5B depicts the output value on path 122 remaining unchanged. FIG. 5C depicts the current on input path corresponding to pin B. As may be easily observed, there is a lower amount of current (of the order of −2 micro ampere maximum).

The charge at pin B may be computed by integrating the curve of FIG. 5C, and the resulting values are represented by the curve of FIG. 5D.

The capacitance value at any point may be determined by dividing the corresponding charge value on curves of FIGS. 4D and 5D by the voltage level. In one embodiment, the charge at time points 450 of FIG. 4D and 550 of FIG. 5D respectively equal 4.9819 fCoulombs and 3.0544 fCoulombs. By using such different values for difference libraries as described above, the timing analysis may be performed accurately.

While the description above is provided with reference to characterizing cell libraries, it should be appreciated that the approaches can be used in general for determining whether an integrated circuit can be operated at a desired clock speed. The load offered with and without switching is considered in performing timing analysis. The description is continued with a illustration of implementing various aspects of the present invention as a software program.

6. Software Implementation

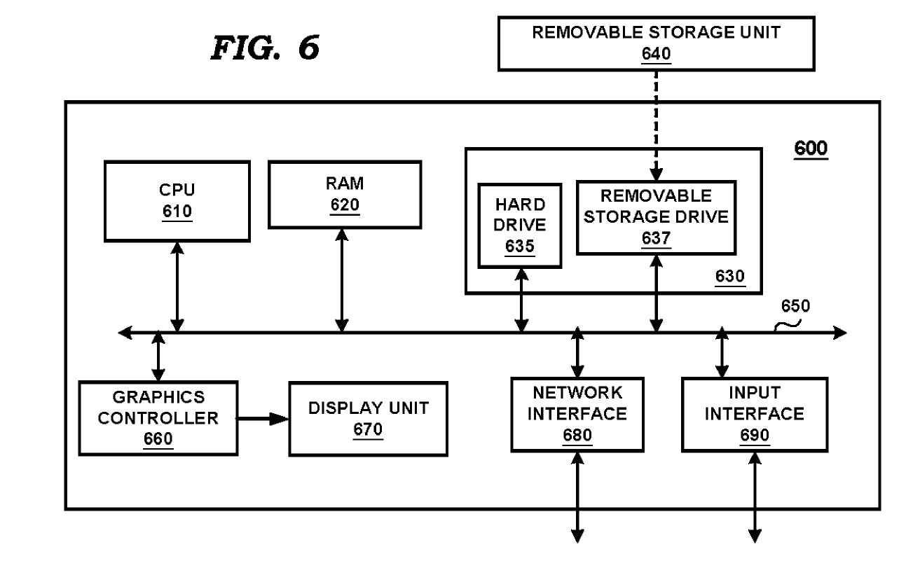

FIG. 6 is a block diagram illustrating the details of computer system 600 in an embodiment of the present invention. Even though computer system 600 is described with specific components and architecture for illustration, it should be understood that the present invention might be implemented in several other types of embodiments.

Computer system 600 may contain one or more processors such as central processing unit (CPU) 610, random access memory (RAM) 620, secondary memory 630, graphics controller 660, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present invention. CPU 610 may contain multiple processing units, with each processing unit potentially being designed for a specific task. Alternatively, CPU 610 may contain only a single processing unit. RAM 620 may receive instructions from secondary memory 630 using communication path 650. Data representing cell libraries and associated data values computed above may be stored and retrieved from secondary memory 630 (and/or RAM 620) during the execution of the instructions.

Graphics controller 660 generates display signals (e.g., in RGB format) to display unit 670 based on data/instructions received from CPU 610. Display unit 670 contains a display screen to display results from timing analysis. Input interface 690 may correspond to a key and/or mouse, and generally enables a user to interact and provide inputs while performing timing analysis.

Secondary memory 630 may contain hard drive 635, flash memory 636 and removable storage drive 637. Secondary storage 630 may store the software instructions and data, which enable computer system 600 to provide several features in accordance with the present invention. Some or all of the data and instructions may be provided on removable storage unit 640, and the data and instructions may be read and provided by removable storage drive 637 to CPU 610. Floppy drive, magnetic tape drive, CD drive, DVD Drive, Flash memory, removable memory chip (PCMCIA Card, EPROM) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable storage medium having stored therein computer software and/or data. An embodiment of the present invention is implemented using software running (that is, executing) in computer system 600.

In this document, the term A computer program product@ is used to generally refer to removable storage unit 640 or hard disk installed in hard drive 635. These computer program products are means for providing software to computer system 600. As noted above, CPU 610 may retrieve the software instructions, and execute the instructions to provide various features of the present invention described above in detail.

7. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

1. OLE_LINK2. A method of determining whether an integrated circuit operates at a clock speed, said integrated circuit comprising a combinatorial element, said method comprising:
determining a load offered by said combinatorial element when an output path of said combinatorial element switches in response to a vector provided as an input to said combinatorial element; and
performing a timing analysis of said integrated circuit by associating said load to a prior element driving said combinatorial element.

2. The method of claim 1, further comprising:
determining another load offered by said combinatorial element when an output path of said combinatorial element does not switch in response to a vector provided as an input to said combinatorial element; and
performing another timing analysis of said integrated circuit by associating said another load to said prior element.

3. The method of claim 2, wherein said timing analysis is performed when said integrated circuit is being analyzed for hold time violations of sequential elements contained in said integrated circuit.

4. The method of claim 2, wherein said another timing analysis is performed when said integrated circuit is being analyzed for setup time violations of sequential elements contained in said integrated circuit.

5. A method of characterizing a load offered by a cell on an input pin, wherein said cell is contained in a library, said method comprising:
determining a first set of input vectors that would cause an output path of a combinatorial element to switch, wherein said combinatorial element is contained in said first cell and connected to said input pin;
measuring a capacitance of said pin when said first set of input vectors are applied to said combinatorial element; and
associating said capacitance to said pin if said cell is to be characterized for setup time violation.

6. The method of claim 5, further comprising:
determining a second set of input vectors that would not cause said output path to switch;
measuring a capacitance of said pin when said second set of input vectors are applied to said combinatorial element; and
associating said capacitance to said pin if said cell is to be characterized for hold time violation.

7. A machine readable medium carrying one or more sequences of instructions for causing a system to determine whether an integrated circuit operates at a clock speed, said integrated circuit comprising a combinatorial element, wherein execution of said one or more sequences of instructions by one or more processors contained in said system causes said one or more processors to perform the actions of:
determining a load offered by said combinatorial element when an output path of said combinatorial element switches in response to a vector provided as an input to said combinatorial element; and
performing a timing analysis of said integrated circuit by associating said load to a prior element driving said combinatorial element.

8. The machine readable medium of claim 7, further comprising:
determining another load offered by said combinatorial element when an output path of said combinatorial element does not switch in response to a vector provided as an input to said combinatorial element; and
performing another timing analysis of said integrated circuit by associating said another load to said prior element.

9. The machine readable medium of claim 8, wherein said timing analysis is performed when said integrated circuit is being analyzed for hold time violations of sequential elements contained in said integrated circuit.

10. The machine readable medium of claim 8, wherein said another timing analysis is performed when said integrated circuit is being analyzed for setup time violations of sequential elements contained in said integrated circuit.

11. A machine readable medium carrying one or more sequences of instructions for causing a system to determine a load offered by a cell on an input pin, wherein said cell is contained in a library, wherein execution of said one or more sequences of instructions by one or more processors contained in said system causes said one or more processors to perform the actions of:
determining a first set of input vectors that would cause an output path of a combinatorial element to switch, wherein said combinatorial element is contained in said first cell and connected to said input pin;
measuring a capacitance of said pin when said first set of input vectors are applied to said combinatorial element; and
associating said capacitance to said pin if said cell is to be characterized for setup time violation.

12. The machine readable medium of claim 11, further comprising:
determining a second set of input vectors that would not cause said output path to switch;
measuring a capacitance of said pin when said second set of input vectors are applied to said combinatorial element; and
associating said capacitance to said pin if said cell is to be characterized for hold time violation.
